(19) United States
(12) Patent Application Publication
(10) Pub. No.: US 2003/0009378 A1
(43) Pub. Date: Jan. 9, 2003

(54) Wireless transmission of data to and from photofinishing equipment

(76) Inventors: Steven H. Schultz, Princeton, NJ (US); Robert S. Ripp, Chatham, NJ (US)

Correspondence Address: DYKEMA GOSSETT PLLC, SUITE 300, 39577 WOODWARD, BLOOMFIELD HILLS, MI, 48304, US

(21) Appl. No.: 10/166,926

(22) Filed: Jun. 10, 2002

Related U.S. Application Data
(60) Provisional application No. 60/297,368, filed on Jun. 11, 2001.

(51) Int. Cl. G06F 17/60; H04M 3/42

(52) U.S. Cl. 705/14; 455/414

(57) ABSTRACT

The method in accordance with this invention involves the use of in-store photo processing equipment. Photo processing equipment called digital / hybrid minilabs and kiosks are installed inside a retail store. This equipment contains a device that can send and receive data wirelessly. The digital/hybrid minilab and/or kiosk can then engage in two-way wireless communication with other wirelessly enabled devices inside the retail store. These devices may be possessed by a consumer shopping at the retail store or installed at the retail store. When interacting with the device, the consumer may create or manipulate data which is then transferred wirelessly back to the kiosk and/or digital/hybrid minilab.

### CROSS-REFERENCE TO RELATED APPLICATIONS

This application claims the benefit of U.S. provisional application Serial No. 60/297,368 filed Jun. 11, 2001, hereby incorporated by reference in its entirety.

### FIELD OF THE INVENTION

This application relates to a method of wireless transmission of data to and from in-store photo finishing equipment.

### BACKGROUND OF THE INVENTION

Manufacturers of consumer photo finishing machines have developed a new generation of equipment called digital minilabs. Digital minilabs use digital technology to process rolls of exposed film into photographic prints or digital images. These and other manufacturers have also developed machines called photo finishing kiosks, where consumers can take digital images, or scan copies of printed photographs, and manipulate the images to make photographic prints or digital images. Some older photo finishing machines can be outfitted with equipment that provides them digital capabilities. These are called hybrid minilabs and can also be manufactured new. A photo finishing machine means one of a digital minilab, a hybrid minilab, or a photo finishing kiosk.

Digitally-enabled photo finishing equipment has functionality that enables them to be networked as seen by reference to U.S. Pat. No. 6,014,691 issued to Brewer et al.

While the primary purpose of digitally-enabled photo finishing equipment is to process consumer film into paper-based or digital images, its networkability makes it a suitable hub for communications. Over 42% of all digital/hybrid minilabs are installed in retail photo finishing outlets, such as supermarkets, drugstores, and mass merchandisers. Over 80% of all film rolls in the United States are processed at these large retailers. More than 35,000 kiosks have been installed at retail stores.

Companies who manufacture and sell consumer products at these retail chains employ various methods inside the retail store to motivate consumers to purchase their products. These methods include, but are not limited to, couponing, advertising (print and electronic), signage (both printed and electronic), radio, product sampling, end-aisle displays, and weekly advertising circulars. In-store marketing is one of the fastest-growing segments of the marketing services industry, with a market size estimated to be just under $1 billion.

It is also known to provide wireless technology, such as wireless modems, for use in connection with computers. In addition, many marketers make use of a tool called a Frequent Shopper Program (FSP) to enhance the effectiveness of their marketing efforts. An FSP collects data about a consumer's purchase behavior and demographic information in exchange for discounts on products purchased by a consumer. A marketer can use this information to tailor offerings to consumers it wants to reach, increasing the probability of purchase which makes the marketing program more efficient.

A problem when executing in-store programs is getting the right materials into the right store at the right time. This is typically done by creating the materials offsite and then shipping them to the retailer. Sometimes items are shipped to stores directly and sometimes items are shipped to a central distribution point for re-distribution to individual stores. In some cases materials can be transmitted to a store electronically. This requires that a physical data line, usually a phone line or broadband connection, be installed in each store. In some cases the retailer may already have a data line installed. In that case the marketing service company wishing to use it must negotiate with the store and adhere to the retailer's policies.

The current method of distributing in-store marketing materials is inefficient and inflexible. Distributing printed materials relies on a logistics system that adds time and cost to the process. Transmitting data over hard lines requires installation and maintenance of a new line. Connectivity is limited by conventional cabling whereby transmitting information to more than one part of the store requires more lines to be installed. There are also limitations on the range of devices that can be connected to the hard line.

There is therefore a need to provide a system for in-store distribution of marketing materials that overcomes one or more of the problems mentioned above.

### SUMMARY OF INVENTION

One object of the present invention is to provide a solution to one or more of the foregoing problems.

A solution involving wireless transmission of data into and within a retail store provides greater efficiency and flexibility. Data may be transmitted wirelessly from a central server to digitally-enabled photo finishing equipment, where it could be printed and distributed. This bypasses more costly logistical systems and accomplishes the task of delivering printed materials to the store in a fraction of the time and cost. Since no hard line needs to be installed, there is lower installation cost and added flexibility from the ability to connect a greater range of devices wirelessly to the digitally-enabled minilab.

The present invention provides a method of wireless communication between digitally-enabled photo finishing equipment and wireless-enabled device, such device being capable of creating/displaying an in-store marketing vehicle such as a coupon, advertisement (print or electronic), signage (printed or electronic), audio broadcast, video broadcast, or other audio, video, or printed material. The present invention further provides a method for communication between in-store digitally-enabled photo finishing equipment and a wireless-enabled device whereby such device will aggregate, process, or transmit data necessary to produce the marketing vehicle and report on the status of that output production in-store. These and other objects, advantages and features are achieved by the present invention, which involves the use of in-store digitally-enabled photo finishing equipment adapted to use wireless technology for data transport. Wireless transmission enables a user to bypass a conventional existing in-store communication infrastructure (e.g. hard wiring, cables, etc.), providing additional flexibility, speed, functionality, and ease of use.

The present invention also provides a method of wireless communication between digitally-enabled photo finishing equipment and equipment configured for implementation of a conventional Frequent Shopper Program (FSP) whereby the data so transmitted wirelessly could be used to tailor offerings for consumers. Such offerings could then be delivered wirelessly to consumers as they shop inside the retail store.

In accordance with the present invention, a method is provided to facilitate the distribution of electronic marketing material. The method comprises the step of wirelessly communicating with a photofinishing machine information that is configured for use in the distribution of electronic marketing material. In one embodiment, the photofinishing machine includes one of a digital minilab, a hybrid minilab, and a photofinishing kiosk. In a further embodiment, the method further includes the substep of wireless transmitting from the photofinishing machine to a wireless-enabled device.

An apparatus for performing the inventive method is also presented.

### BRIEF DESCRIPTION OF THE DRAWINGS

Other objects, features and advantages will be apparent to one skilled in the art from following detailed descriptions and accompanying drawings, in which:

FIG. 1 is a schematic and block diagram of a system according to the invention, capable of performing the inventive method.

FIG. 2 is a flow chart showing the inventive method wirelessly transmitting data to and from digitally-enabled photo finishing equipment.

FIG. 3 is a flow chart showing the inventive method for a consumer-based application.

FIG. 4 is a flow chart showing the inventive method for a retailer-based application.

### DETAILED DESCRIPTION OF PREFERRED EMBODIMENTS

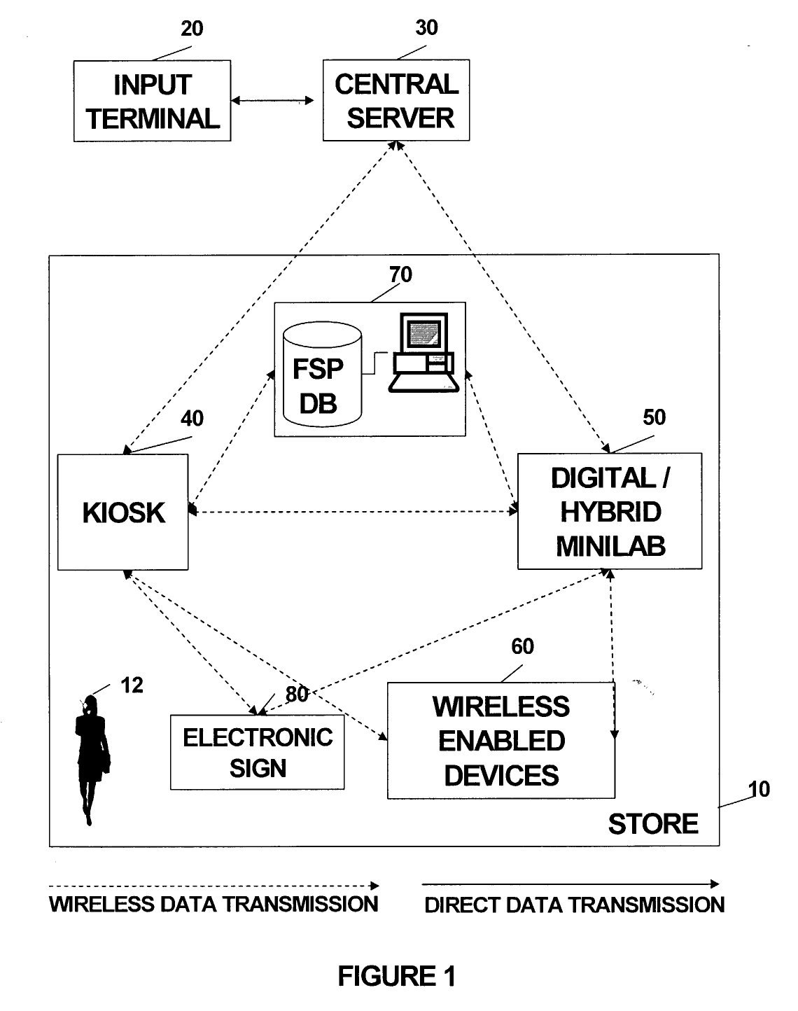

FIG. 1 shows a store 10 employing the inventive method. A consumer 12 may visit store 10, which may include digital/hybrid minilab equipment 50, and/or kiosk equipment 40, wireless enabled devices 60 and other accessories such as an electronic sign 80. Also shown in FIG. 1, but not contained within store 10, is an offsite central server 30 and an input terminal 20.

This inventive method is a centralized network linking digitally-enabled photo finishing equipment installed inside a retail location to deliver targeted marketing vehicles. Data is input through a computer connected to the network via the Internet or a direct connection. The data is prepared for wireless transmission by a central server and then transmitted wirelessly to digitally-enabled photo finishing equipment based upon criteria set by the user. Upon arrival at the digitally-enabled photo finishing machine, the data may be used to create a marketing vehicle, or passed on to another wireless-enabled device that would then create or display a marketing vehicle.

The inventive method enables a first entity, such as marketers for example only, to transmit data wirelessly to a digitally-enabled photo finishing machine, where it can then be used to generate marketing vehicles by the digital/hybrid minilab or kiosk. The inventive method also allows data to be retransmitted from the digitally-enabled photo processing machine to another wirelessly-enabled device capable of generating or displaying marketing information vehicles. Marketing vehicles is a term used to describe the different mediums marketers use to send product messages. The inventive method also enables any wirelessly-enabled transmission device to have two-way communication with the digital/hybrid minilab or kiosk, whose function is to aggregate, report, retransmit, or otherwise manipulate the data but not necessarily create marketing vehicles.

After the marketing vehicle has been delivered, the device would then wirelessly transmit data to the digitally-enabled photo finishing machine. That machine would then wirelessly transmit the data back to the centralized server where it could be viewed, stored and used by the end-user.

Store 10 is any business that offers on-site photo processing services. Photo processing services include but are not limited to (i) development of film negatives into photo prints and producing standard and novelty prints from existing photos or (ii) from files captured from a digital camera or other equipment. Photo processing equipment 40 and 50 includes digital photo minilabs and photo kiosks and any other equipment for processing photographs from negatives, digital cameras, or other digital media, or creating standard or novelty prints. Digital/hybrid minilabs include equipment located at store 10 that provides the capability to wirelessly connect to wireless enabled devices. Photo finishing equipment 40/50 each have a wireless communications port for bidirectional wireless communications. In one embodiment, information that is configured for use in the distribution of electronic coupons.

Photo kiosks 40 include equipment located at store 10 and may comprise systems that have a PC with a scanner and a touch-screen monitor, and may be enclosed in a free-standing case and/or have the capability to read diskettes or CD-ROMs or other storage media. Kiosks are configured for consumer operation and for making standard and novelty prints from existing photos or digital images. Kiosks are easy-to-use, low cost and have a small physical footprint. Kiosks 40 in accordance with the present invention have the ability to wirelessly connect to wireless enabled devices 60.

Central server 30 is provided to connect, preferably wirelessly, to photo processing equipment 40 and 50. Input terminal 20 is any computer connected to central server 30, either via the Internet, direct connection, virtual private network, or dial-up connection. Central server 30 can be any system that allows wireless two-way communication between itself and kiosk 40 and/or digital/hybrid minilab 50. Server 30 includes a database having the ability to aggregate and prepare data to be transmitted wirelessly to kiosk 40 and minilab 50. Server 30 includes the necessary hardware for wireless data transmission to digitally-enabled photo finishing machines. Server 30 may be configured to support predetermined traffic levels as known in the art.

Wireless enabled devices 60 are devices that interface wirelessly either directly with a consumer or with retail merchandising systems inside a store. For example, a direct consumer interface could be a marketing vehicle transmitted to a consumer's cellular telephone or PDA as they shop inside store 10. The consumer would be alerted to the marketing vehicle for possible use during their shopping trip. Communications with a retail merchandising system, for example, could include data transmission to an electronic sign, inventory tracking system or audio broadcast system in store 10.

Data is input at input terminal 20 and transferred to central server 30. Central server 30 then prepares the data for wireless transmission. Data transfer includes two-way wireless communication from central server 30 to kiosk 40 and digital/hybrid minilab 50. Data transfer also includes two-way wireless communication between kiosk 40 and digital/hybrid minilab 50, kiosk 40 and wireless enabled devices 60, and digital/hybrid minilab 50 and wireless enabled devices 60. The data transfers include Consumer Data, Image Data, Activity Data, Processing Data, and Vehicle Data. Wireless transmission technology is known per se in the art, and the present invention may be implemented using common off-the-shelf wireless transmission technologies, such as Cellular (e.g. 3G), Radio Frequency (RF), Infrared (IR) and others.

Security provides two-way encryption/decryption capabilities between input terminal 20 and central server 30; central server 30 and kiosk 40; central server 30 and digital/hybrid minilab 50; kiosk 40 and digital/hybrid minilab 50; frequent shopper data 70 and kiosk 40; frequent shopper data 70 and digital/hybrid minilab 50; kiosk 40 and wireless enabled devices 60; digital/hybrid minilab 50 and wireless enabled devices 60. These capabilities ensure the integrity of the inventive method, the information being transmitted and avoids data fraud. This is important since some of this information may be considered personal. Encryption/decryption capabilities may be provided using common off-the-shelf (COTS) technology, and which comprise any one of a number of known approaches.

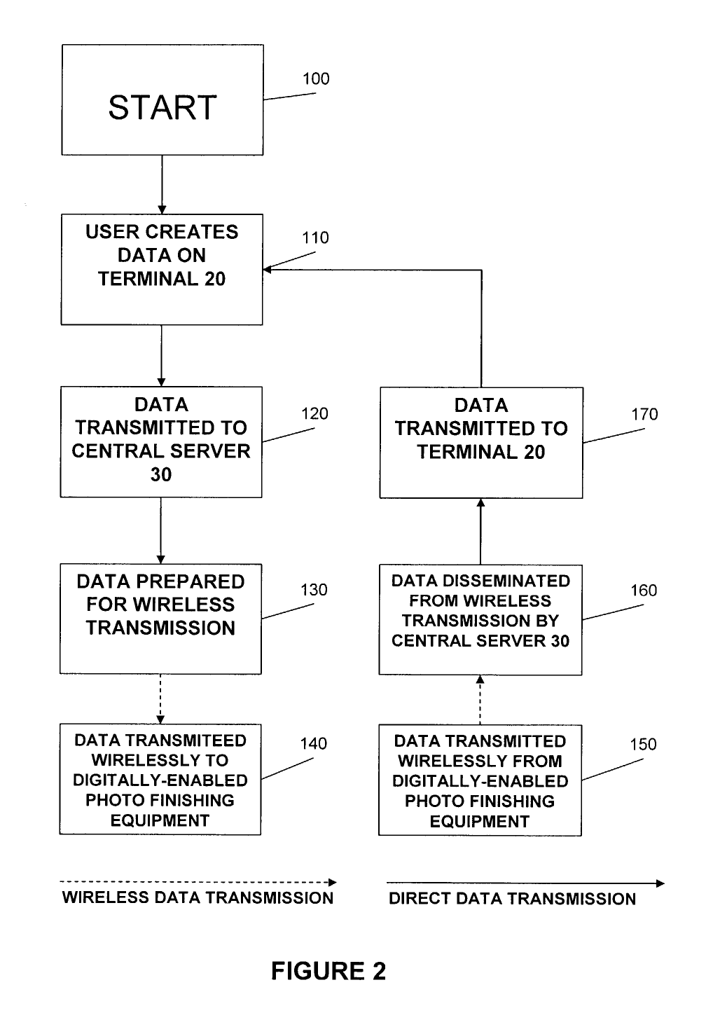

Referring now to FIG. 2, the inventive method for transferring data wirelessly to and from digitally-enabled photo finishing equipment will be described. In step 110, a user creates data on terminal 20. That data may be any of the data groups referred to above, and which may be used to facilitate distribution of one or more electronic marketing materials. That data is transmitted to central server 30 in step 120. Central server 30 is equipped with a communications port featuring a device that enables data to be transmitted wirelessly to digitally-enabled photo finishing equipment. Central server 30 prepares the data to be transmitted wirelessly in step 130. In step 140, the data is then transmitted wirelessly to digitally-enabled photo finishing equipment. Data may also be transmitted wirelessly from digitally-enabled photo finishing equipment to central server 30. In step 150, the data is wirelessly transmitted from digitally-enabled photo finishing equipment, where it is disseminated in step 160 by central server 30. In step 170, the data is transmitted to terminal 20 where it can be viewed and manipulated by the end user.

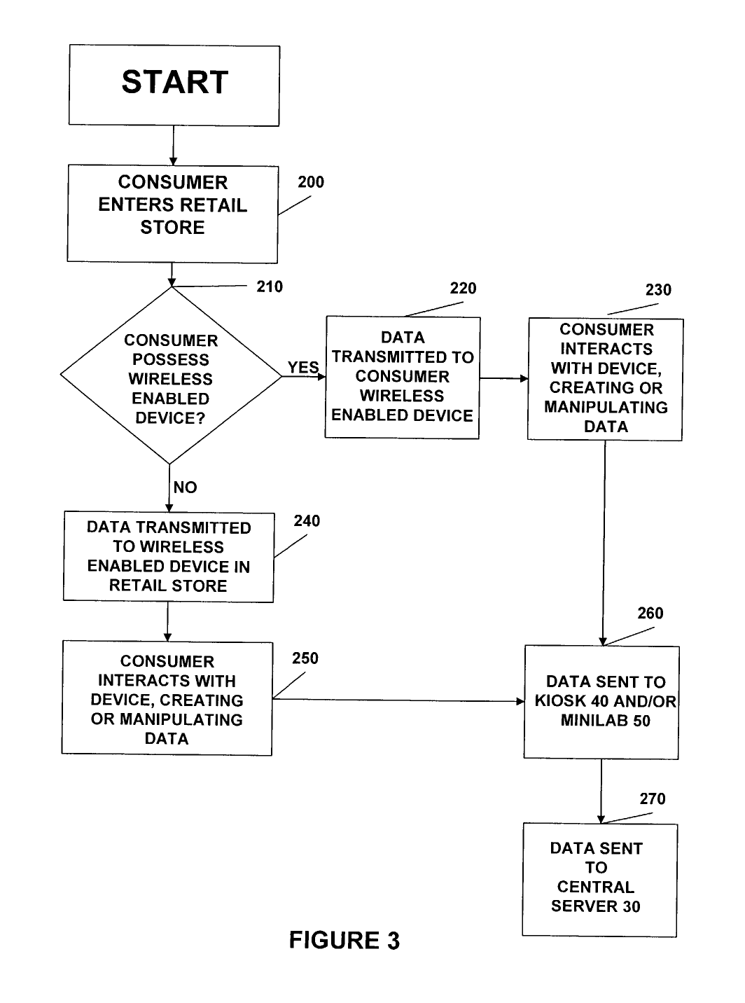

Referring now to FIG. 3, the inventive method for a consumer application will be described. The system is designed to be dynamic, exchanging information between the various wireless and digital devices. In step 200, a consumer visits a store 10. In step 210, the consumer may be in possession of a wireless enabled device 60 that has been configured to accept wireless transmissions from a kiosk 40 or digital/hybrid minilab 50. This may be accomplished using known communications and/or synchronization approaches. During their retail store visit the wireless enabled device 60 accepts the wireless transmissions as noted in step 220. For example, a shopper may own personal digital assistant (PDA) capable of receiving wireless data. Upon entering the store, the PDA displays a message transmitted by kiosk 40 or digital/hybrid minilab 50. In step 230 the consumer interacts with the wireless enabled device 60, creating, viewing, or otherwise manipulating data. The wireless enabled device 60 sends data wirelessly about that interaction to a kiosk 40 or minilab 50 a shown in step 260. For example, a consumer may have just accepted an offer displayed on their PDA and instructed it to be automatically redeemed when they checkout. In step 270 the data is transmitted back to the central server 30 where it can be viewed or manipulated on terminal 20. For example, at specific intervals the data may be sent back to the server where it can be reviewed by marketers to assess whether the offers generated in store 10 increased sales in that store.

If in step 210 the consumer does not possess a wireless enabled device 60, the consumer may then interact with a wireless enabled device 60 installed by the retail store. This device is configured to accept wireless transmissions from kiosk 40 or digital/hybrid minilab 50. In step 240 the consumer interacts with the wireless enabled device 60, creating, viewing, or otherwise manipulating data. The wireless enabled device 60 sends data wirelessly about that interaction to a kiosk 40 or digital/hybrid minilab 50 a shown in step 260. In step 270 the data is transmitted back to the central server 30 where it can be viewed or manipulated on terminal 20.

As an example, an electronic sign installed inside the store may accept a wireless transmission from kiosk 40 or digital/hybrid minilab 50 and display a message. A consumer may review that message or be prompted to interact with the sign, perhaps by pushing a button, to receive other offers. After the consumer interaction the sign could wirelessly transmit data to the kiosk 40 or digital/hybrid minilab 50, which then sends it to central server 30. Marketers can assess performance of the offer by reviewing the data on central server 30. The sign may be changed frequently to optimize the offers being generated, enabling marketers to determine the right offers to maximize product purchases.

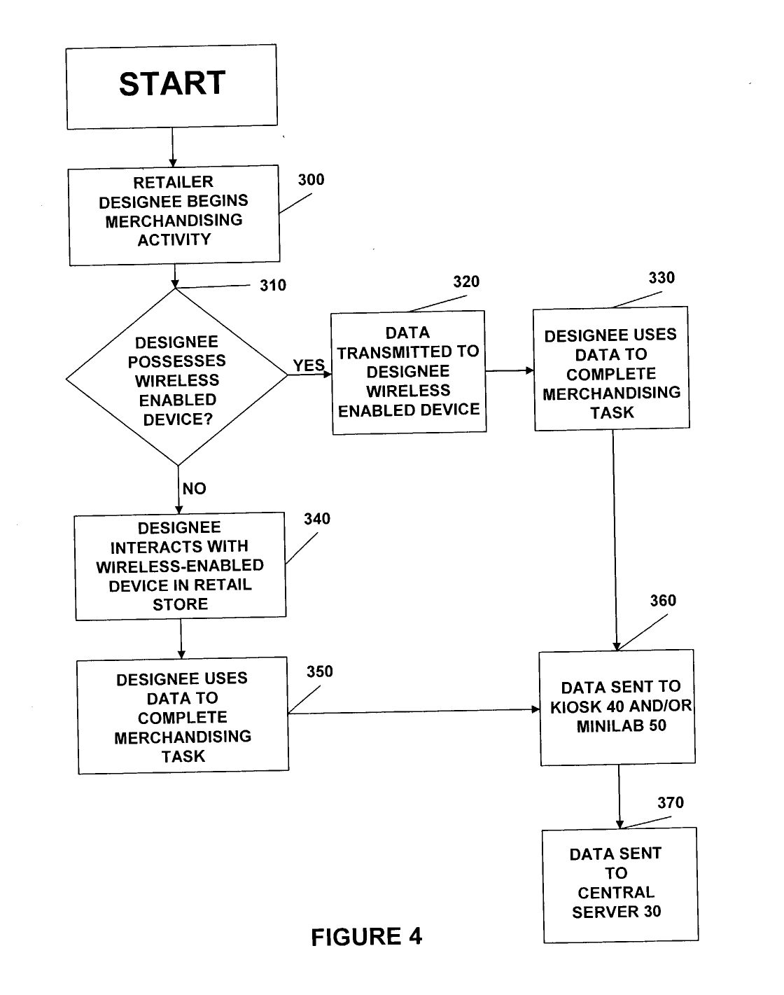

Referring now to FIG. 4, a designee at retail store 10 is assigned to perform merchandising activity. A designee is any person assigned by a retailer to perform merchandising activity. Merchandising activity is generally comprised of tasks that prepare a product to be sold to the consumer. For example, placing the product on the store shelf along with appropriate marketing vehicles to alert the consumer to pertinent information about the product is a common merchandising activity. In step 310, the designee may possess a wireless enabled device, such as a handheld radio frequency transmitter used to track and maintain inventory. If the designee possess the device, in step 320 data is wirelessly transferred from kiosk 40 or digital/hybrid minilab 50 to wireless enabled device 60. After transmission, the designee uses the data to complete a merchandising task as shown in step 330. For example, the designee could use the device to report that they have just completed stocking a store location with product and transmit pertinent data about that activity, making the inventory process more accurate and efficient. In step 360 data is then transferred to kiosk 40 or digital/hybrid minilab 50 where it is sent to central server 30.

In instances where the retailer designee does not posses a wireless enabled device 60, then the designee may interact with devices installed in retail store 10 as shown in step 340. For example, this could be a fixed bar code scanner such as is usually found in a stores checkout lane. In step 350 the designee uses the data to complete a merchandising task. In step 360 data is then transferred to kiosk 40 or digital/hybrid minilab 50 where it is sent to central server 30.

The type of data transmitted includes Consumer Data, Image Data, Activity Data, Processing Data, and Vehicle Data.

Consumer Data may include but is not limited to a consumer's name, address, telephone number, frequent shopper program (FSP) identifier, retailer-assigned unique customer identifier, network-assigned unique consumer identifier, age, sex, household income, pets (including type of pets and number in household), offspring (including number of offspring, sex, ages and names), education, marital status, work status, hobbies, types of automobiles owned, types of wireless devices owned, home ownership status, place of birth, date of birth, ethnic background, and religion.

Consumer Data will be protected against unauthorized use. The system may utilize various encryption technologies to securely transmit data from the central server to the local site.

Image Data may include but is not limited to a location where an exposed roll of film has been dropped off for development, a location where it was processed, a location where it was picked up by the consumer after drop-off, a type of capture device (including but not limited to devices such as a digital camera, analog camera or scanner),a type of capture media (such as but not limited to type of film, memory card type, scanner file format), a date photo was taken, a date photo was printed, a size of photo for printing, the number of copies printed, a universal product code (UPC) image and information, an advertising image, any of the Consumer Data noted above, a wireless device type, an image quality (including but not limited to dots per inch (DPI), color depth, original size), a wireless device transmission data, an image file data, an in-store product quantity and an inventory level.

Activity Data may include but is not limited to marketing vehicle distribution data (including but not limited to number of marketing vehicles distributed, geographic location of distribution, retailer, Consumer Data of consumer who received vehicle), marketing vehicle redemption data (including but not limited to number of vehicles redeemed, geographic location of redemption, store chain redeemed, Consumer Data of redeemer), orders processed, and number of reprints.

Processing Data may include but is not limited to processed photo print size, print quantity (including but not limited to number of prints ordered and number of prints made), order date, print date, payment method, production site, production equipment, production comments or notes, delivery destination, print options, print corrections, image manipulations, tracking number, twin check number, order number, frequent shopper number, file type number and promotional data.

Vehicle Data may include but is not limited to type of vehicle (including but not limited to coupon, advertisement, sweepstakes, rebate offer, licensed characters or artwork, point-of-sale material, in-store print signage, in-store electronic signage, shelf-mounted advertisement, audio clip, video clip, CD-ROM), size of vehicle, vehicle text, vehicle layout, vehicle serial number, vehicle location, and vehicle expiration date.

Wireless enabled devices are devices capable of sending and receiving wireless data, including but not limited to cellular telephones, pagers, personal digital assistants (PDA's), computers, digital cameras, video cameras, televisions, radios, two-way handheld communication devices (such as “walkie-talkies”), CB radios, personal audio systems (such as a “Walkman”), handheld RF scanners, electronic shelf tags, electronic signage, point-of-sale terminals, printers, remote keyless entry systems, and alarm systems.

An example of a data flow follows. A consumer has decided that in order to receive discounts on products purchased from a specific retailer, they will provide information about themselves. They fill out an application with information on it such as name, address, family status, income level, education, occupation and other data as noted in the Consumer Data section above. The retailer will provide the consumer with a Frequent Shopper Card to be scanned at checkout each time the shopper makes a purchase. This information is stored by the retailer in Frequent Shopper Database 70.

A marketer has determined that to increase sales of Brand X, they want to provide offers in-store to shoppers who match a certain demographic profile. The enter the appropriate demographic information, such as address, income level, or family status into an input terminal where it is transferred to central server 30. The central server 30 then sends that information wirelessly to kiosk 40 and/or digital/hybrid minilab 50 where it then resides.

The shopper enters the store with a roll of film to be developed. To receive a discount on the film, they show their frequent shopper card to the department clerk. The department clerk swipes the card and enters the order into the digital/hybrid minilab interface. The digital/hybrid minilab accepts the order and automatically scans a database to see if there is a match between the demographic information entered by the marketer and the Frequent Shopper Card just entered into the system. If it finds a match, it will generate an offer and wirelessly transmit data back to the central server 30. The offer (e.g. an electronic coupon) is then sent to the shopper using one of the mechanisms outlined above, such as wireless transmission to a wireless-enabled device like a cellular telephone or PDA. It should be understood that the coupon or offer is not limited or necessarily even related to the photofinishing activity, although it may be.

We claim:

1. A method for facilitating the distribution of electronic coupons comprising the step of wirelessly communicating with a photofinishing machine information configured for use in the distribution of electronic marketing material.

2. The method of claim 1 further comprising the step of selecting said photofinishing machine from the group comprising a digital minilab, a hybrid minilab, and a photofinishing kiosk.

3. The method of claim 2 wherein said photofinishing machine is a first photofinishing machine, and wherein said step of wirelessly communicating includes the substep of:
transmitting said information from said first photofinishing machine to a second photofinishing machine.

4. The method of claim 2 wherein said photofinishing machine is a first photofinishing machine, and wherein said step of wirelessly communicating includes the substep of:
transmitting said information from said second photofinishing machine to said first photofinishing machine.

5. The method of claim 4 further comprising the step of selecting said second photofinishing machine from the group comprising a digital minilab, a hybrid minilab, and a photofinishing kiosk.

6. The method of claim 2 wherein said step of wirelessly communicating includes the substep of:
transmitting said information from said photofinishing machine to a wirelessly-enabled device.

7. The method of claim 2 wherein said step of wireless communicating includes the substep of:
transmitting said information from a wirelessly-enabled device to said photofinishing machine.

8. The method of claim 2 wherein said step of wirelessly communicating includes the substep of:
transmitting said information from said photofinishing machine to a computing device having a database configured to store data associated with a frequent shopper program (FSP).

9. The method of claim 2 wherein said step of wirelessly communicating includes the substep of:
transmitting said information from a computing device having a database configured to store data associated with a frequent shopper program (FSP) to said photofinishing machine.

10. The method of claim 2 wherein said step of wirelessly communicating includes the substep of:
transmitting said information from said photofinishing machine to a central server having a database configured to store data associated with said electronic coupon.

11. The method of claim 2 wherein said step of wirelessly communicating includes the substep of:
transmitting said information from a central server having a database configured to store data associated with said electronic coupon to said photofinishing machine.

12. A system for distributing electronic coupons comprising:
a central server having a first database configured to store first data associated with said distribution of said electronic coupons;
a photofinishing machine coupled to said central server, said photofinishing machine having a wireless communications port for communicating information configured for use in the distribution of electronic coupons.

13. The system of claim 12 wherein said communications port comprises said coupling to said central server.

14. The system of claim 12 wherein said photofinishing machine comprises one of a digital minilab, a hybrid minilab, and a photofinishing kiosk.

15. The system of claim 12 wherein said photofinishing machine comprises a first photofinishing machine, said system further including a second photofinishing machine having a respective wireless communications port for communicating information configured for use in the distribution of electronic coupons; said first and second photofinishing machines each being configured for bidirectional wireless communications with each other via respective wireless communications ports.
